(19) United States
(12) Patent Application Publication
(10) Pub. No.: US 2009/0136753 A1
(43) Pub. Date: May 28, 2009

(54) METHOD FOR MANUFACTURING OPTICAL FIBER PREFORM, OPTICAL FIBER PREFORM AND OPTICAL FIBER MANUFACTURED USING THE SAME

(76) Inventors: Ji-Sang Park, Seoul (KR); Byung-Yoon Kang, Gyeonggi-do (KR); Soon-II Sohn, Gyeonggi-do (KR); Hyung-Soo Shin, Seoul (KR); Yune-Hyoun Kim, Gyeonggi-do (KR); Lae-Hyuk Park, Seoul (KR)

Correspondence Address: STROOCK & STROOCK & LAVAN LLP, 180 MAIDEN LANE, NEW YORK, NY, 10038, US

(21) Appl. No.: 12/282,480

(22) PCT Filed: Dec. 19, 2006
(86) PCT No.: PCT/KR2006/005569

§ 371 Date: Sep. 10, 2008

(30) Foreign Application Priority Data
Mar. 10, 2006 (KR) 10-2006-0022747

(51) Int. Cl. C03B 37/018; G02B 6/00

(52) U.S. Cl. 428/375; 65/399

(57) ABSTRACT

The present invention relates to a method for manufacturing an optical fiber preform using an MCVD process comprising (A) forming a predetermined thickness of a cladding layer in a preform tube by repeating a unit process of heating an outer peripheral surface of the preform tube at 1,700 to 2,5000 C using a heat source moving in a process direction, and simultaneously injecting cladding layer forming gas and chlorine (Cl) gas into the preform tube; and (B) forming a predetermined thickness of a core layer in the preform tube by repeating a unit process of heating the outer peripheral surface of the preform tube at 1,700 to 2,5000 C using the heat source moving in a process direction, and simultaneously injecting core layer forming gas and chlorine (Cl) gas into the preform tube having the cladding layer.

### TECHNICAL FIELD

The present invention relates to a method for manufacturing an optical fiber preform, and in particular, to a method for manufacturing an optical fiber preform which simultaneously injects chlorine (Cl₂) gas and deposition layer forming gas into a preform tube in a deposition process, thereby preventing diffusion of hydroxyl groups occurring during the deposition process.

### BACKGROUND ART

Generally, an optical fiber has a core therein for transmitting light, and a cladding having different refractive index from the core so that total reflection of light is made at the core. Here, diameters of the core and the cladding determine the optical property of the optical fiber. At this time, the refractive index of the cladding should be smaller than the refractive index of the core for forming an optical waveguide. And, glass is coated on the outside of the optical fiber, which standardizes the size of the optical fiber and protects the outside of the cladding.

The optical fiber is manufactured by drawing an optical fiber preform into fine strips having a predetermined peripheral diameter.

Conventionally, a method for manufacturing an optical fiber uses a modified chemical vapor deposition (hereinafter referred to as MCVD) process. Typically, the MCVD process emits material gas with oxygen gas, heats the outside of a quartz tube using a heat source, deposits a glass film on the inside of the quartz tube by the unit of layer several times and collapses the quartz tube, and a resultant preform is drawn into a plurality of strips, i.e. optical fibers.

A conventional method for manufacturing an optical fiber using such an MCVD process includes injecting deposition layer forming gas, for example SiCl₄, GeCl₄, POCl₃ and O₂ into the inside of a quartz tube, heating the outer side of the quartz tube with a heat source of high temperature, generating glass particles through an oxidation reaction of the injected deposition layer forming gas, depositing the generated glass particles on the inside of the quartz tube through a thermophoretic effect, and vitrifying the generated glass particles by the heat source of high temperature. However, the optical fiber manufactured through the MCVD process may be subjected to optical loss caused by hydroxyl groups (OH−).

To prevent optical loss caused by hydroxyl groups as described above, a method for manufacturing an optical fiber preform is suggested, in which heavy hydrogen gas is provided to remove hydroxyl groups, as disclosed in Korean Laid-open Patent Publication No. 2005-53475 (titled method and apparatus for manufacturing an optical fiber preform and an optical fiber containing few hydroxyl groups). And, another method for manufacturing an optical fiber preform is suggested, in which a multi-layered cladding layer is formed to remove hydroxyl groups, as disclosed in Korean Laid-open Patent Publication No. 2003-21823 (titled an optical fiber preform and fabrication method thereof).

The method for manufacturing an optical fiber preform of '53475 is described below with reference to FIG. 1.

As shown in FIG. 1, the method maintains a temperature of a heat source to a temperature for a glass particle generation reaction, for example 900 to 1,200° C., slowly moves the heat source along the lengthwise direction of a quartz tube, heats the outside of the quartz tube, injects SiCl₄, GeCl₄, POCl₃ and O₂ into the inside of the quartz tube to form a porous cladding deposition layer on the inside of the quartz tube (S1). Next, the method heats again the quartz tube in the lengthwise direction of the quartz tube using the heat source and injects dehydration reaction gas including chlorine (Cl₂) gas into the inside of the quartz tube to remove hydroxyl groups of the deposited cladding layer and sinter the porous cladding deposition layer (S2). Subsequently, the method forms a porous core deposition layer on the cladding layer under the same process conditions (S3), and removes hydroxyl groups contained in the inside of the core layer and sinters the porous core layer (S4).

However, the method for manufacturing an optical fiber preform of '53475 involves a dehydration process in a typical process for forming a deposition layer, thereby resulting in increased manufacturing time and thus reduced productivity of the optical fiber preform.

The method for manufacturing an optical fiber preform of '21823 is described below with reference to FIG. 2.

As shown in FIG. 2, the above-mentioned Laid-open Patent Publication No. '21823 is designed to solve the optical loss problem caused by the hydroxyl groups (OH−) in an MCVD process by increasing a diffusion distance of the hydroxyl groups. Specifically, a multi-layered cladding layer is formed such that a ratio (D/d) of a peripheral diameter of the cladding layer (D) to a diameter of the core (d) is 2.0 or more.

However, the method for manufacturing an optical fiber preform of '21823 increases a process time so as to increase the value of D/d, thereby resulting in reduced productivity, and in practice, hardly reduces the optical loss caused by the hydroxyl groups in the deposition layer.

### DISCLOSURE OF INVENTION

### Technical Problem

The present invention is designed to solve the above-mentioned problems, and therefore it is an object of the present invention to provide a method for manufacturing an optical fiber preform, in which deposition layer forming gas is injected with chlorine gas in a deposition process using a modified chemical vapor deposition method to effectively remove hydroxyl groups (OH−) without an additional dehydration process, and an optical fiber preform and an optical fiber manufactured thereby.

### Technical Solution

In order to achieve the above-mentioned object, a method for manufacturing an optical fiber preform using a modified chemical vapor deposition (MCVD) process according to the present invention includes (A) forming a predetermined thickness of a cladding layer in a preform tube by repeating a unit process of heating an outer peripheral surface of the preform tube at 1,700 to 2,500° C. using a heat source moving in a process direction, and simultaneously injecting cladding layer forming gas and chlorine (Cl₂) gas into the preform tube; and (B) forming a predetermined thickness of a core layer in the preform tube by repeating a unit process of heating the outer peripheral surface of the preform tube at 1,700 to 2,500° C. using the heat source moving in a process direction, and simultaneously injecting core layer forming gas and chlorine (Cl₂) gas into the preform tube having the cladding layer.

Preferably, the heat source reciprocates at the moving speed of 100 to 250 mm/min.

According to the present invention, the injection amount of the chlorine (Cl₂) gas to the injection amount of the whole gas satisfies the range of 0.5 to 20 sscm %.

Preferably, hydroxyl groups (OH−) in the cladding layer and the core layer, and the chlorine (Cl₂) gas injected into the preform tube satisfy a reaction formula of 2OH+Cl₂→2HCl+O₂.

The present invention provides an optical fiber preform manufactured by the above-mentioned manufacturing method and an optical fiber manufactured using the preform.

### BRIEF DESCRIPTION OF THE DRAWINGS

FIG. 1 is a flowchart of a conventional deposition process using a modified chemical vapor deposition method.

FIG. 2 is a cross-sectional view of a conventional optical fiber.

FIG. 3 is a view illustrating a cladding layer forming step in accordance with a preferred embodiment of the present invention.

FIG. 4 is a view illustrating a core layer forming step in accordance with a preferred embodiment of the present invention.

FIG. 5 is a graph illustrating comparison of loss between an optical fiber in accordance with a preferred embodiment of the present invention and a conventional optical fiber.

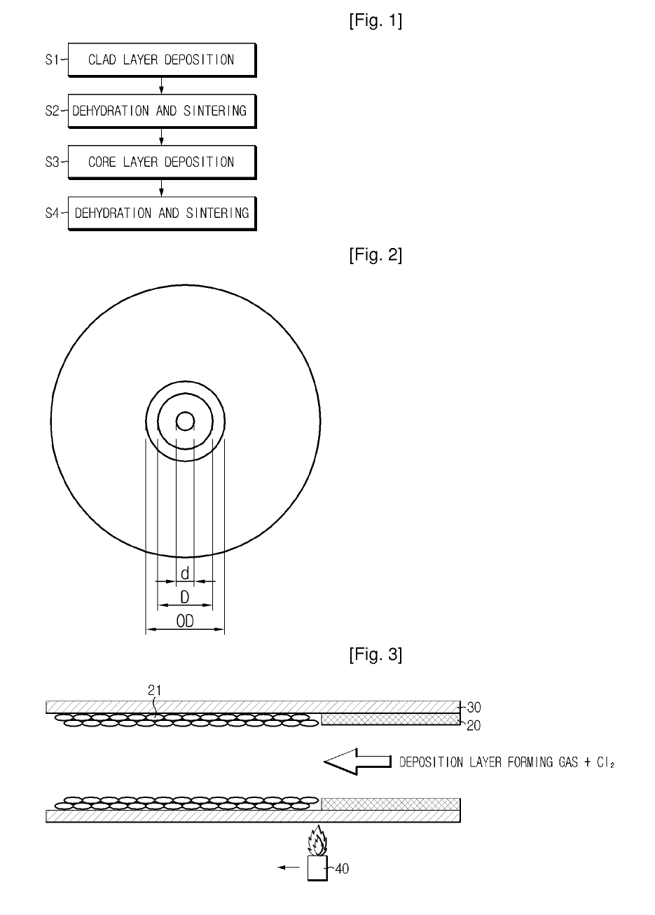

### BEST MODE FOR CARRYING OUT THE INVENTION

Hereinafter, preferred embodiments of the present invention will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

An optical fiber preform according to the present invention is manufactured using a modified chemical vapor deposition (hereinafter referred to as MCVD) process.

Here, a preform tube used in manufacturing the optical fiber preform uses a high purity quartz tube. The preform tube is made of high purity quartz materials, i.e. silicon dioxide (SiO₂), which reinforces the mechanical strength of a deposition layer to be described below and prevents moisture and corrosion.

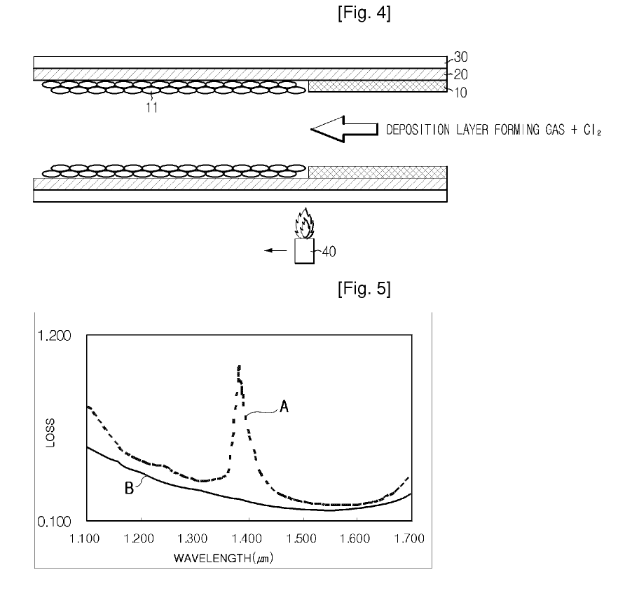

With reference to FIGS. 3 and 4, a deposition process for sequentially forming a cladding layer and a core layer on an inner surface of the above-mentioned preform tube will be described.

As shown in FIG. 3, forming the cladding layer includes giving flames to an outer peripheral surface of a rotating preform tube 30 using a heat source 40, for example a torch, with slowly moving the heat source 40 in a process direction, and simultaneously injecting deposition layer forming gas and chlorine (Cl₂) gas into the preform tube 30. At this time, it is preferred that the temperature of the heat source 40 is kept in the range of 1,700 to 2,500° C., and the reciprocating speed of the heat source 40 is kept in the range of 100 to 250 mm/min.

The cladding layer 20 is formed by injecting the mixed gas into the preform tube 30. At this time, the preform tube 30 maintains a predetermined temperature range by the heat source 40, and the mixed gas includes cladding layer forming gas and chlorine (Cl₂) gas mixed at a predetermined ratio. Here, it is preferred that the internal temperature of the preform tube 30 is between and 1,600 and 2,400° C., but it is not limited in this regard. At this time, the injection rate of the chlorine gas to the injection rate of the whole mixed gas satisfies the range of 5 to 20 sccm %, but is not limited in this regard. For example, the injection rate of the chlorine gas may be 0.5 to 20 sccm % according to process conditions.

Here, the cladding layer forming gas (SiCl₄, GeCl₄, POCl₃, BBr₃, BCl₃, CCl₂F₂ and O₂) is deposited on the inner surface of the preform tube 30 located in front of the heat source 40 by a thermophoretic phenomenon and accumulated into soot particles 21 of SiO₂ and GeO₂, and the accumulated soot particles 21 are sintered and vitrified by the immediately approaching heat source 40 to form a sintered layer, i.e. the cladding layer 20.

At this time, the chlorine gas injected simultaneously with the cladding layer forming gas prevents moisture or hydroxyl groups (OH−) from flowing into the accumulated cladding layer. Specifically, the chlorine gas injected simultaneously with the cladding layer forming gas into the preform tube 30 prevents the hydroxyl groups (OH−) from diffusing and permeating into the cladding layer 20 area according to the following chemical formula 1.

2OH+Cl₂→2HCl+O₂ [Chemical Formula 1]

More specifically, the hydroxyl groups (OH−) are removed using the chlorine gas according to the above reaction formula 1, in order to prevent the case that the hydroxyl groups (OH−) are bonded with P₂O₅, GeO₂, or SiO₂ deposited on the cladding layer 20 area to form P—O—H, Ge—O—H or Si—O—H bond.

When a single-layered cladding layer is completed by the above process, a cladding layer forming process is repeated until the cladding layer has a desired thickness.

Next, as shown in FIG. 4, the outer peripheral surface of the preform tube 30 having the inner surface with the cladding layer 20 is heated by the heat source 40 moving slowly in a process direction at the moving speed of 100 to 250 mm/min and providing the temperature of 1,700 to 2,500° C. At the same time, the method mixes core layer forming gas and chlorine (Cl₂) gas at a predetermined ratio and injects the mixed gas into the preform tube 30.

At this time, the heat source 40 maintains uniformly the internal temperature of the preform tube 30 while reciprocating in the lengthwise direction of the preform tube 30. And, the heat source 40 injects the core layer forming gas and chlorine (Cl₂) gas into the preform tube 30.

At this time, it is preferred to adjust the injection amount of the chlorine (Cl₂) gas to the injection amount of the whole gas to the range of 5 to 20 sccm %.

The core layer forming gas is converted into fine soot particles by an oxidation reaction, and forms a porous deposition layer on the inner surface of the preform tube 30 located in front of the heat source 40 by a thermophoretic phenomenon. And, the accumulated soot particles 11 are sintered and vitrified by the immediately approaching heat source 40 to form the core layer 10.

At this time, the chlorine gas injected simultaneously with the core layer forming gas removes moisture and hydroxyl groups (OH−) in the accumulated porous layer to prevent the hydroxyl groups (OH−) from permeating into the core layer. That is, the chlorine gas injected simultaneously with the core layer forming gas prevents the hydroxyl groups (OH−) from diffusing and permeating into the core layer 20 area according to the above chemical formula 1.

When a single-layered core layer is formed by the above process, a core layer forming process is repeated until the core layer has a desired thickness. When formation of the core layer is completed, the optical fiber preform having a hollow therein is produced.

After the optical fiber preform is manufactured, a collapsing process for removing the hollow of the preform tube 30 having the core layer 10 and the cladding layer 20, and a drawing process are performed to complete the manufacture of the optical fiber.

And, before the drawing process is performed, a rod in tube (RIT) process may be performed, in which a preform rod is inserted into the preform tube larger than an outer peripheral diameter of the preform rod and the preform tube is collapsed with high temperature to obtain the preform rod having a larger diameter.

The optical fiber manufactured by the above-mentioned process has the increased chlorine contents included in the deposition layer forming step, and thus a physical characteristic of the optical fiber including loss and scattering loss caused by the hydroxyl groups is improved.

FIG. 5 is a graph illustrating comparison of loss between an optical fiber in accordance with a preferred embodiment of the present invention and a conventional optical fiber.

Referring to FIG. 5, an X-axis of the graph is a wavelength band of the manufactured optical fiber and its unit is nanometer (nm), whereas a Y-axis of the graph is transmission loss of the optical fiber and its unit is decibel per unit length (dB/Km). The dotted line ‘A’ indicates an optical fiber manufactured by a conventional manufacturing method, and the solid line ‘B’ indicates an optical fiber manufactured by the present invention.

Here, the conventional optical fiber having a wavelength band characteristic of the line ‘A’ has a relatively large transmission loss at the wavelength band of 1,385 nm area. However, the optical fiber of the present invention having wavelength band characteristic of the line ‘B’ has smaller transmission loss than the conventional optical fiber. In particular, the optical fiber has a small transmission loss at the wavelength band of 1,385 nm area. Thus, the optical fiber manufactured by the present invention enables a broad use of relatively enlarged wavelength band, i.e. a long wavelength and a short wavelength, compared with the conventional optical fiber. And, as the optical fiber has higher chlorine contents, a fictive temperature of the optical fiber reduces, and thus scattering loss reduces thereby to reduce other area loss than hydroxyl group loss.

Hereinabove, preferred embodiments of the present invention has been described in detail with reference to the accompanying drawings. However, it should be understood that the detailed description and specific examples, while indicating preferred embodiments of the invention, are given by way of illustration only, since various changes and modifications within the spirit and scope of the invention will become apparent to those skilled in the art from this detailed description.

### INDUSTRIAL APPLICABILITY

As described above, the method for manufacturing an optical fiber preform according to the present invention simultaneously injects the deposition layer forming gas and chlorine gas into the quartz tube in a deposition process, thereby effectively preventing optical loss caused by diffusion of hydroxyl groups.

And, the method of the present invention achieves the reduced manufacturing time and a simple process, compared with a conventional manufacturing method, thereby improving the manufacturing efficiency and productivity of products.

Further, the present invention prevents an increase of absorption loss caused by diffusion of hydroxyl groups to provide an optical fiber with low loss and high quality, available in a long wavelength and a short wavelength.

1. A method for manufacturing an optical fiber preform using a modified chemical vapor deposition (MCVD) process, the method comprising:
(A) forming a predetermined thickness of a cladding layer in a preform tube by repeating a unit process of heating an outer peripheral surface of the preform tube at 1,700 to 2,5000 C using a heat source moving in a process direction, and simultaneously injecting cladding layer forming gas and chlorine (Cl) gas into the preform tube; and
(B) forming a predetermined thickness of a core layer in the preform tube by repeating a unit process of heating the outer peripheral surface of the preform tube at 1,700 to 2,5000 C using the heat source moving in a process direction, and simultaneously injecting core layer forming gas and chlorine (Cl) gas into the preform tube having the cladding layer.

2. The method for manufacturing an optical fiber preform of claim 1, wherein the injection amount of the chlorine (Cl) gas to the injection amount of the whole gas satisfies the range of 0.5 to 20 sccm %.

3. The method for manufacturing an optical fiber preform of claim 2, wherein the heat source reciprocates at the moving speed of 100 to 250 mm/min.

4. The method for manufacturing an optical fiber preform of claim 3, wherein the internal temperature of the preform tube is between 1,800 and 2,2000 C.

5. An optical fiber preform manufactured using the method for manufacturing an optical fiber preform of claim 4.

6. An optical fiber manufactured using the optical fiber preform of claim 5.

7. An optical fiber preform manufactured using the method for manufacturing an optical fiber preform of claim 2.

8. An optical fiber preform manufactured using the method for manufacturing an optical fiber preform of claim 3.

9. An optical fiber preform manufactured using the method for manufacturing an optical fiber preform of claim 4.

10. An optical fiber manufactured using the optical fiber preform of claim 7.

11. An optical fiber manufactured using the optical fiber preform of claim 8.

12. An optical fiber manufactured using the optical fiber preform of claim 9.
